(19) United States
(12) Patent Application Publication
(10) Pub. No.: US 2018/0120877 A1
(43) Pub. Date: May 3, 2018

(54) PRECISE VOLTAGE POSITIONING USING DC-DC CONVERTER

(71) Applicant: Analog Devices, Inc., Norwood, MA (US)

(72) Inventor: Jun Zhao, Fremont, CA (US)

(21) Appl. No.: 15/336,367

(22) Filed: Oct. 27, 2016

(51) Int. Cl. G05F 1/575; H02M 3/158

(52) U.S. Cl. CPC G05F 1/575; H02M 3/158

(57) ABSTRACT

Techniques to control the start point of an output voltage of a power supply for a short period after receive a “stop switching” signal, which will switch a DC-DC switching regulator from a pulse width modulation (PWM) mode to a linear mode to precisely position the output voltage at a certain level. In this way, the power supply can remove any output ripple caused by the PWM mode and can minimize or remove the sampling error to a low-power system in every cycle. In addition, the power supply can intelligently communicate a “power ready” signal back to the system, resulting in a synchronized system.

### FIELD OF THE DISCLOSURE

This disclosure relates generally to power supply devices.

### BACKGROUND

Electronic systems can include devices that utilize a regulated power source. Power converter circuitry can be used to provide a circuit supply rail having a regulated voltage. A linear regulator, e.g., a low dropout (“LDO”) regulator, can have the advantage of a high power supply rejection ratio (“PSRR”) and low output noise performance, which is widely used to power up noise sensitive rails in, for example, analog to digital converters, digital to analog converters, and radiofrequency circuitry. A DC-DC regulator, however, often has better conversion efficiency when compared to LDOs.

### SUMMARY OF THE DISCLOSURE

This disclosure describes techniques to control the start point of an output voltage of a power supply for a short period after receive a “stop switching” signal, which will switch a DC-DC switching regulator from a pulse width modulation (PWM) mode to a linear mode to precisely position the output voltage at a certain level. In this way, the power supply can remove any output ripple caused by the PWM mode and can minimize or remove the sampling error to a low-power system in every cycle. In addition, the power supply can intelligently communicate a “power ready” signal back to the system, resulting in a synchronized system.

In some aspects, this disclosure is directed to a method of controlling operation of a power supply. The method comprises generating an output voltage using a switched-mode power conversion of the power supply, upon receipt of a first level of a first signal, stopping the generating using the switched-mode power conversion, after stopping the generating using the switched-mode power conversion, generating the output voltage using a linear regulation of the power supply, and adjusting the linear regulation based on a voltage feedback signal to generate a predetermined output voltage.

In some aspects, this disclosure is directed to a power supply comprising a switching regulator, a linear regulator, and a controller configured to generate an output voltage using a switched-mode power conversion of the switching regulator; upon receipt of a first level of a first signal, stop generating the output voltage using the switched-mode power conversion; after stopping the generating using the switched-mode power conversion, generate the output voltage using a linear regulation of the linear regulator; and adjust the linear regulation based on a voltage feedback signal to generate a predetermined output voltage.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a graph depicting a simplified load profile of a low power mixed-signal chipset.

FIG. 2 is a simplified block diagram of an LDO solution to supply power to an IC.

FIG. 3 is a simplified block diagram of a DC-DC solution to supply power to an IC.

FIG. 4 is a simplified block diagram of a DC-DC plus LDO solution to supply power to an IC.

FIG. 5 graphically depicts a switching operation status of an example DC-DC at Stop Switching solution.

FIG. 6 graphically depicts a DC output of an existing DC-DC at Stop Switching solution.

FIG. 7 is a simplified block diagram of an example system implementing various precise voltage positioning techniques of this disclosure.

FIG. 8 graphically depicts a DC output of an example of a DC-DC at Stop Switching solution in accordance with this disclosure.

FIG. 9 graphically depicts a DC output of another example of a DC-DC at Stop Switching solution in accordance with this disclosure.

FIG. 10 is a block diagram depicting various example components of a DC-DC at Stop Switching solution in accordance with this disclosure.

FIG. 11 is a flow diagram depicting an example method implementing various precise voltage positioning techniques of this disclosure.

### DETAILED DESCRIPTION

As mentioned above, linear regulators, e.g., low dropout (“LDO”) regulators, can have a high power supply rejection ratio (“PSRR”) and low output noise performance, and a DC-DC switching regulator often has better conversion efficiency when compared to LDOs. To power analog loads, analog signal-chain system power designs can combine the DC-DC switching regulator and the LDO regulator in order to achieve both benefits of the system efficiency and clean supply rails.

As low-power systems continue to evolve, they can require higher performance and lower power consumption in order to extend battery life in applications including, for example, Internet-of-Things (IOT), low-power sensors, battery-powered equipment, battery powered energy meters, and energy harvesting devices. Low-power systems are often run at low-duty operation with burst current in order to save overall average power.

This disclosure describes techniques to control the start point of an output voltage of a power supply for a short period after receive a “stop switching” signal, which will switch the DC-DC switching regulator from a pulse width modulation (PWM) mode to a linear mode to precisely position the output voltage at a certain level. In this way, the power supply can remove any output ripple caused by the PWM mode and can minimize or remove the sampling error to a low-power system in every cycle. In addition, using various techniques of this disclosure, the power supply can intelligently communicate a “power ready” signal back to the system, resulting in a synchronized system.

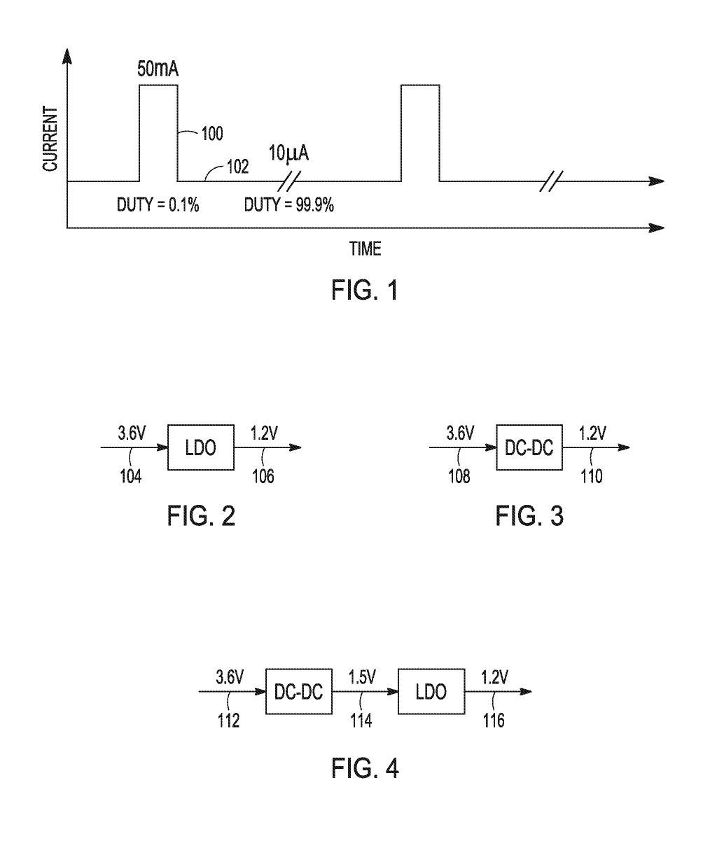

FIG. 1 is a graph depicting an example of a simplified load profile of a low power mixed-signal chipset. In FIG. 1, the x-axis represents time and the y-axis represents current. In an active mode, a sensor chip can turn on its operation and finish data conversion in a very low duty cycle like 0.1% at 50 milliamp (mA) peak, shown at 100. Because this is a mixed-signal chip, in its operation, it can be sensitive to external power supply noise.

The chip can be in an idle mode most of the time at 99.9% duty cycle and can consume about 10 uA, as shown at 102. During the idle mode period, most chip functionality can be disabled so there is no power supply noise requirement. However, there can be a threshold level of supply voltage threshold needed in order to keep the chip running.

As seen in the example load profile in FIG. 1, the average current of the example chip can be calculated as (50 mA×0.1%+10 microamp×99.9%), or about 60 microamps. Although other low-power systems can have more complicated operation modes than the simplified example in FIG. 1, they often behave similarly.

Power circuitry designs can be challenging. For example, designing power circuitry to achieve very high efficiencies to power up low-power ICs can be challenging. As another example, designing power circuitry to satisfy the power supply noise requirement for some mixed-signal ICs, including those mixed-signal ICs with many sensitive analog blocks including analog-to-digital converter (ADC), digital-to-analog converter (DAC), clock, and voltage controlled oscillators (VCO), phase locked loop (PLL), for example, can be challenging. A large output ripple of the power supply is generally not desirable.

By way of specific example, consider a low-power integrated circuit (IC) that requires a 1.2 volt (V) supply voltage that utilizes a typical burst current load profile, while the system runs from a 3.6V battery, e.g., Li+ battery. Considering a supply noise requirement and high-efficiency requirements, some possible solutions to power up the IC are shown in FIGS. 2-4.

FIG. 2 is a simplified block diagram of an LDO solution to supply power to an IC. The input voltage 104 to the LDO is 3.6V and the output voltage 106 is 1.2V. The efficiency of the LDO solution is relative low. For a high input voltage, the ratio is 1.2V/3.6V, or about 33%.

FIG. 3 is a simplified block diagram of a DC-DC solution to supply power to an IC. The input voltage 108 to the DC-DC converter, e.g., switching regulator, is 3.6V and the output voltage 110 is 1.2V. The efficiency of the switching regulator can be very high, e.g., over 80%. However, due to its power saving mode operation, the output ripple can be relatively large, e.g., about 50 mV. Thus, the DC-DC switching regulator solution may not be desirable to power up the mixed-signal load with its sensitive analog blocks.

FIG. 4 is a simplified block diagram of a DC-DC plus LDO solution to supply power to an IC. The input voltage to the DC-DC switching regulator is 3.6V and the output voltage of the DC-DC switching regulator is 1.5V. The output voltage 114 of the DC-DC switching regulator is fed to the input of the LDO and the output voltage 116 of the LDO is 1.2V. The DC-DC switching regulator plus LDO solution of FIG. 4 can provide a trade-off between efficiency and noise, but can add cost and increase the number of components. The DC-DC switching regulator plus LDO solution of FIG. 4 is still a relatively inefficient solution.

Another solution exists, referred to in this disclosure as a “DC-DC at Stop Switching” solution, that can improve on some of the limitations of the solutions in FIGS. 2-4. An example of the “DC-DC at Stop Switching” solution is implemented in Analog Devices' ultralow power step-down regulator ADP5300/2. The DC-DC converter can include a stop input pin (STOP) that can temporarily stop the switching regulator in hysteresis mode. When a logic high level is applied to the STOP pin, a buck regulator can stop switching immediately. When a logic low level is applied to the STOP pin, the buck regulator can resume switching.

In some battery-powered systems, the microcontroller unit (MCU) of the system can command the regulator to stop switching via the STOP signal, and the regulator can then rely on an output capacitor to supply the load. In this period, a quiet system environment can be achieved, thereby benefitting the noise sensitive circuitry, such as data conversion circuitry, RF data transmission circuitry, and analog sensing circuitry. After the noise sensitive circuitry completes its task, the MCU can control the regulator and resume its switching regulation mode. If needed, an output voltage OK signal (“VOUT_OK”) signal can monitor the output voltage in the event it dips too low to latch up the system.

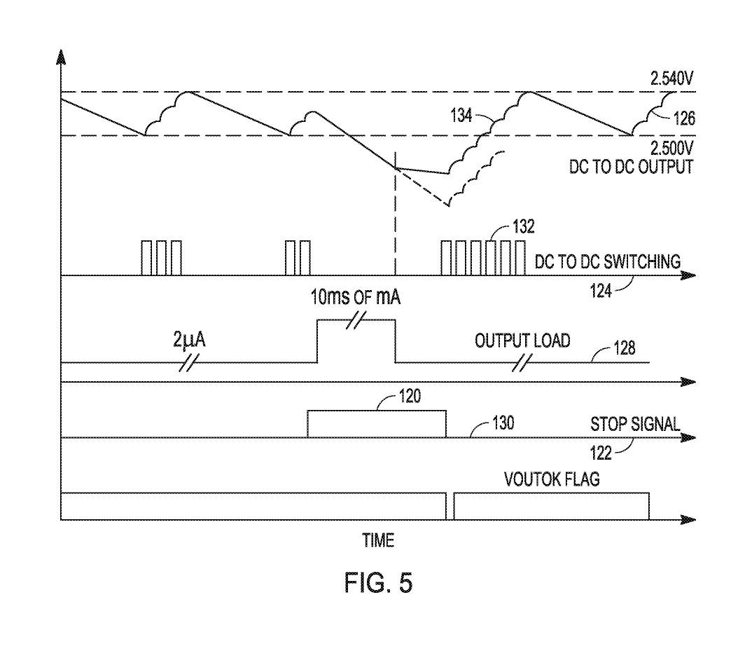

FIG. 5 graphically depicts a switching operation status of an example DC-DC at Stop Switching solution. In particular, FIG. 5 depicts the STOP switching operation status in Analog Devices' ultralow power step-down regulator ADP5300/2. The DC-DC at Stop Switching solution of the ADP5300/2 can achieve good efficiency like traditional lower-power DC-DC converters, and can also generate a quiet environment for the mixed-signal system to achieve high performance in its active operation. It also adds no hardware cost and solution size to the system.

As seen in FIG. 5, upon receipt of a logic high level 120 of a STOP signal 122, the DC to DC switching 124 can be temporarily stopped and then the regulator can rely on an output capacitor to provide the DC to DC output 126 to supply the output load 128. Upon receipt of a logic low level 130 of the STOP signal 122, the buck regulator can resume switching at 132 and the DC to DC output 126 begins increasing at 134.

The metrics of the “DC-DC at Stop Switching” solution are an improvement upon the solutions in FIGS. 2-4. The present inventor, however, has recognized that the DC-DC at Stop Switching solution still can have limitations. For example, due to the non-synchronized STOP signal, the output voltage 126 can stop at different times and output voltage levels, which can result in errors. Every time a mixed-signal IC performs a sensitive operation by turning on its active mode, e.g., to perform a data conversion, the IC can see a different voltage, which can result in an error, e.g., sampling errors.

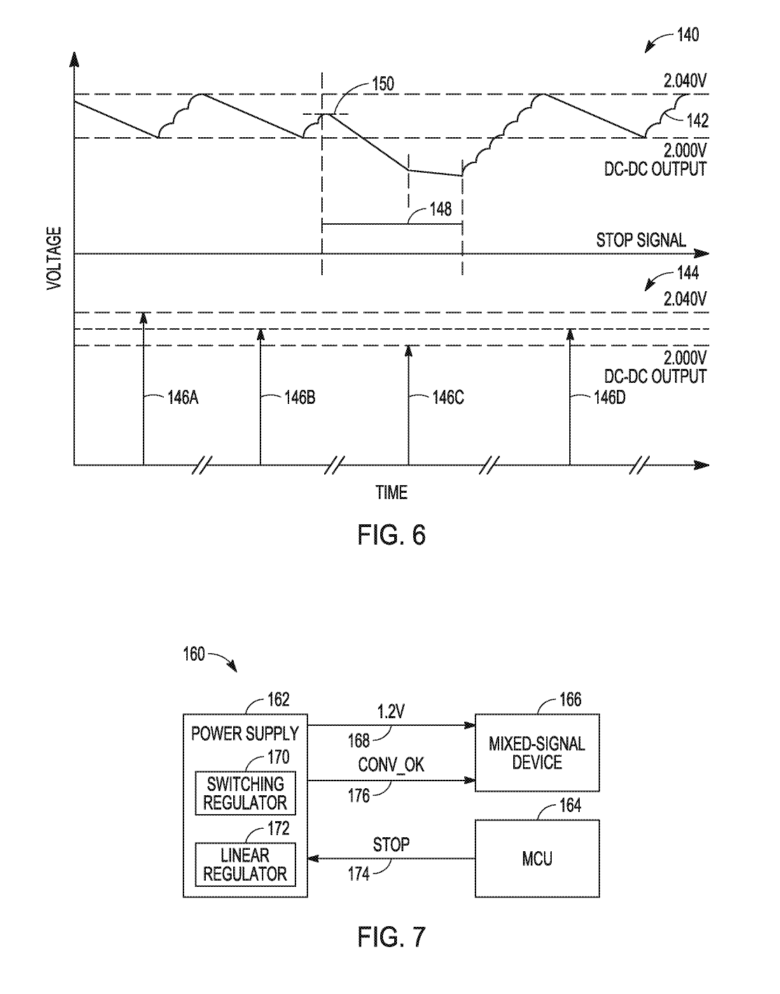

FIG. 6 graphically depicts a DC output of an existing DC-DC at Stop Switching solution. The top graph 140 depicts the DC-DC output 142 between a ripple range of 2.040V and 2.000V, and the bottom graph 144 depicts sampling voltages 146A-146D. The x-axis represents time and the y-axis represents voltage.

The system MCU does not know or cannot control the DC-DC regulator operation condition, so when the MCU sends a “STOP” command 148, e.g., a logic high signal, the DC-DC regulator can stop switching at any possible output voltage 142, within its ripple range, while the STOP command is enabled. The top graph 140 depicts the DC-DC regulator stopping at one example sampling voltage 150.

The bottom graph 144 depicts various example sampling voltages 146A-146D ranging between the limits 2.040V (e.g., 146A) and 2.000V (e.g., 146C) of the ripple range, and voltages therebetween (e.g., 146B, 146D). The differences between these sampling voltages is the sampling error that can be caused by the DC-DC at Stop Switching solution.

To overcome the limitations of various previous solutions, the present inventor proposes power supply circuitry that can achieve “precise-voltage positioning” at every STOP switching operation for a low-power DC-DC regulator. The power supply circuitry of this disclosure can achieve higher signal-chain performance of a mixed-signal IC, or can at least reduce its uncertainty of voltage variations. This disclosure describes techniques that can include an advanced intelligent communication between a power supply and mixed-signal devices as a synchronized system.

FIG. 7 is a simplified block diagram of an example system implementing various precise voltage positioning techniques of this disclosure. The example system 160 of FIG. 7 can include a DC-DC converter shown as power supply 162, an MCU 164, and a mixed-signal IC 166. Example mixed-signal ICs can include ADC circuitry, RF circuitry, analog front end (AFE) circuitry, and the like. As seen in the example in FIG. 7, the power supply 162 can generate and supply an output voltage 168, e.g., 1.2V, to the mixed-signal IC 166.

The operation of the example system 160 in FIG. 7 is as follows. The power supply 162 can include a DC-DC switching regulator 170 and a linear regulator 172. The power supply can generate an output voltage 168, e.g., 1.2V, using the switching regulator 170 to perform a switched-mode power conversion, and supply the output voltage 168 to the mixed-signal device 166.

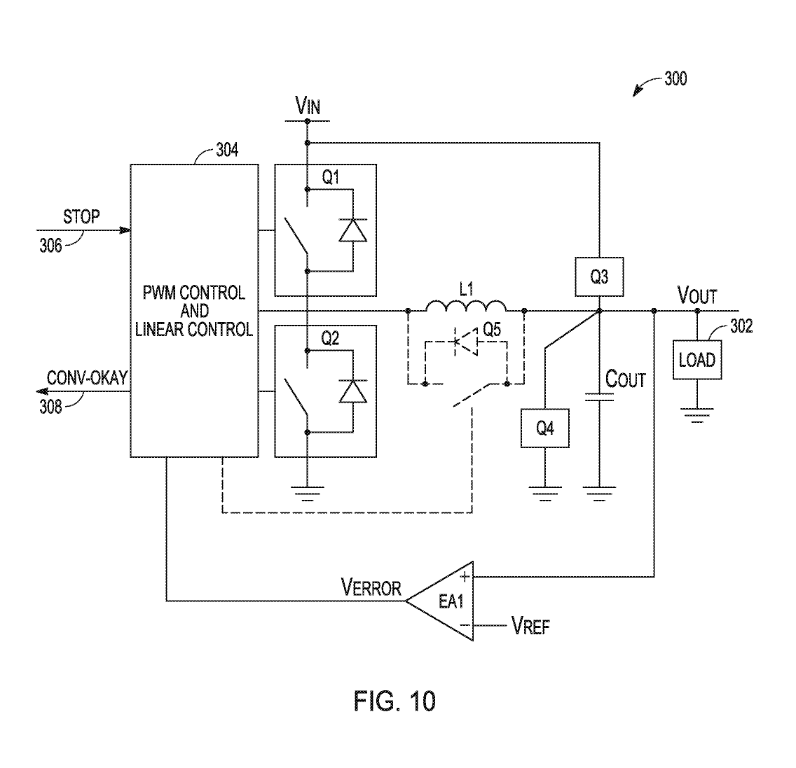

The MCU 164 can send a first level of a first signal, e.g., a logic high of a STOP signal 174, to the power supply 162. Upon receipt of STOP signal 174, the power supply 162 can stop generating the output voltage 168 using the switched-mode power conversion. The power supply 162 can change its internal operation to linear operation mode. That is, after the power supply 162 stops generating the output voltage using the switched-mode power conversion, the power supply can generate the output voltage 168 using the linear regulator 172, e.g., LDO, of the power supply 162 and can adjust a linear regulation based on a voltage feedback signal to generate the output voltage 168 at a precise output voltage, e.g., a predetermined output voltage. A detailed implementation is described in detail below with respect to FIG. 10.

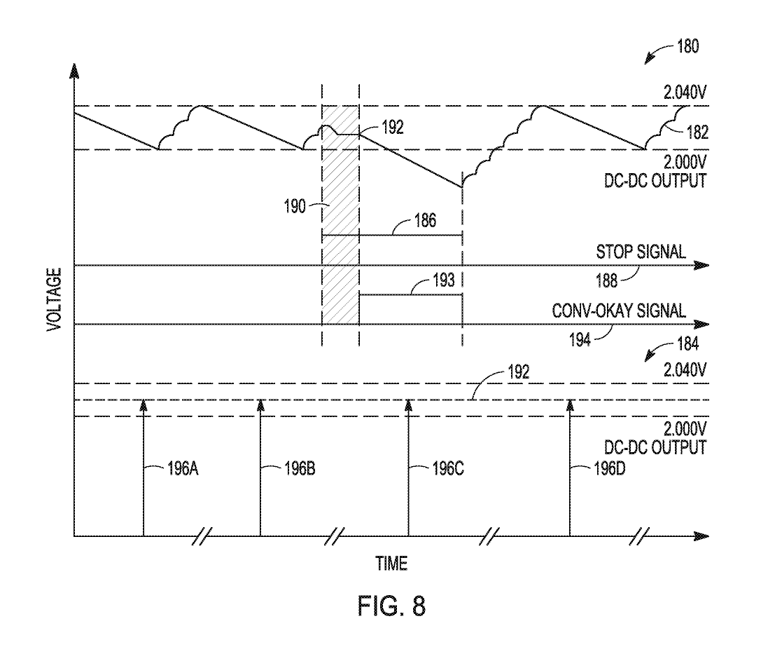

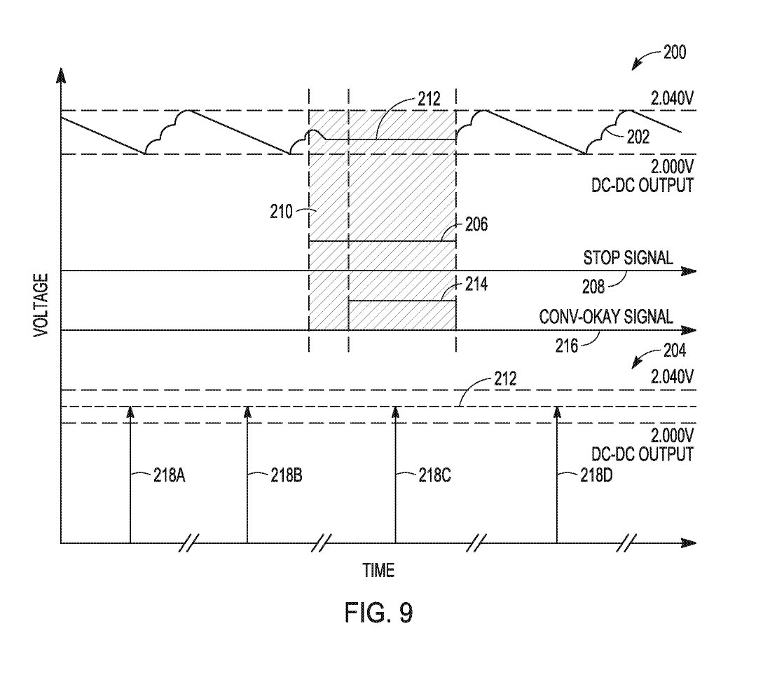

In some example implementations, the power supply 162 can switch to the linear regulation mode and use the linear regulator 172 to achieve a stable voltage, then the power supply 162 can stop the linear regulation mode operation and rely on one or more output capacitors to supply the load, e.g., COUT of FIG. 10, as described below with respect to FIG. 8. In other example implementations, the power supply 162 can switch to the linear regulation mode to achieve a stable voltage, but then continue to use the linear regulation mode to achieve a well-regulated output voltage to supply the load in its active period, as described below with respect to FIG. 9.

After the power supply 162 regulates its output voltage 168 to be at a certain stable level, then the power supply 162 can, in some examples, send a signal 176 to the mixed-signal device 166 as an indication that the power supply 162 is ready for the precision operation of the mixed-signal device 166. For example, after the power supply 162 regulates its output voltage 168 to be at a certain stable level, then the power supply 168 can send a “convert OK” signal, e.g., a logic high CONV_OK signal 176, to the mixed-signal device 166 as the indication that the power supply 162 is ready for a data conversion.

FIG. 8 graphically depicts a DC output of an example of a DC-DC at Stop Switching solution in accordance with this disclosure. The top graph 180 depicts the DC-DC output 182 between a ripple range of 2.040V and 2.000V, and the bottom graph 184 depicts sampling voltages. The x-axis represents time and the y-axis represents voltage.

In accordance with this disclosure, the power supply 162 (e.g., of FIG. 7) can generate an output voltage 182 using a switched-mode power conversion, e.g., by switching regulator 170 of the power supply 162. Upon receipt of a first level 186 of a first signal 188, e.g., a STOP signal from the MCU 164 of FIG. 7, the power supply 162 can stop generating the output voltage 168 using the switched-mode power conversion.

After the power supply 162 stops generating the output voltage using the switched-mode power conversion, the power supply 162 can enter a linear regulation mode 190 and can generate the output voltage 168 using a linear regulator 172 of the power supply 162. Then, the power supply 162 can adjust the linear regulation based on a voltage feedback signal to generate a predetermined output voltage 192. In this manner, the power supply 162 can achieve a precise voltage level. In the example in FIG. 8, the power supply 162 can stop the linear mode operation after achieving the precise voltage level, e.g., at level 192, and can then rely on one or more output capacitors to supply the load.

In some example implementations, after the power supply 162 regulates its output voltage to be at a certain stable level, e.g., at level 192, then the power supply 162 can send a “power-ready” signal, e.g., a logic high 193 of a CONV-OKAY signal 194 to the mixed-signal device 164 as an indication that the power supply 162 is ready for the precision operation of the mixed-signal device 164, e.g., data conversion.

The bottom graph 184 depicts various example sampling voltages 196A-196D between the limits 2.040V and 2.000V of the ripple range. As seen in the bottom graph 184, the sampling voltages 196A-196D are maintained at the particular voltage level 192. Because there is little to no difference between these sampling voltages 196A-196D, the sampling error caused by the DC-DC at Stop Switching solution has been reduced or eliminated.

FIG. 9 graphically depicts a DC output of another example of a DC-DC at Stop Switching solution in accordance with this disclosure. The top graph 200 depicts the DC-DC output 202 between a ripple range of 2.040V and 2.000V, and the bottom graph 204 depicts sampling voltages. The x-axis represents time and the y-axis represents voltage.

In accordance with this disclosure, the power supply 162 (e.g., of FIG. 7) can generate an output voltage 202 using a switched-mode power conversion, e.g., by switching regulator 170 of the power supply 162. Upon receipt of a first level of a first signal, e.g., a logic high 206 of a STOP signal 208 from the MCU 164 of FIG. 7, the power supply 162 can stop generating the output voltage 168 using the switched-mode power conversion.

After the power supply 162 stops generating the output voltage 168 using the switched-mode power conversion, the power supply 162 can enter a linear regulation mode 210 and can generate the output voltage 168 using a linear regulator 172 of the power supply 162. Then, the power supply 162 can adjust the linear regulation based on a voltage feedback signal to generate a predetermined output voltage 212. In this manner, the power supply 162 can achieve a precise voltage level. In the example in FIG. 9, the power supply 162 can switch to the linear regulation mode to achieve a stable voltage 212, and then continue to use the linear regulation mode to achieve a well-regulated output voltage 212 to supply the load in its active period.

After the power supply 162 regulates its output voltage 168 to be at a certain stable level, e.g., at level 212, then the power supply 162 can send a “power-ready” signal, e.g., a logic high 214 of a CONV-OKAY signal 216, to the mixed-signal device 166 as an indication that the power supply 162 is ready for the precision operation of the mixed-signal device 166, e.g., data conversion.

The bottom graph 204 depicts various example sampling voltages 218A-218D between the limits 2.040V and 2.000V of the ripple range. As seen in the bottom graph 204, the sampling voltages 218A-218D are maintained at a particular voltage level 212. Because there is little to no difference between these sampling voltages 218A-218D, the sampling error caused by the DC-DC at Stop Switching solution has been reduced or eliminated.

FIG. 10 is a block diagram depicting various example components of a DC-DC at Stop Switching solution in accordance with this disclosure. As seen in FIG. 10, a power supply 300, e.g., a DC-DC converter, is configured to provide the DC-DC at Stop Switching solution is shown connected to a load 302, e.g., a low-power pulsed load. The power supply 300 is an example of the power supply 162 of FIG. 7.

The power supply 300 depicted in FIG. 10 can include a pulse width modulation (PWM) and linear controller 304 to control one or more DC-DC switched-mode regulator components of a switching regulator, e.g., switching regulator 170 of FIG. 7, and linear regulator components of a linear regulator, e.g., linear regulator 172 of FIG. 7. For purposes of conciseness, FIG. 10 depicts four components that can operate as linear regulators, labeled Q1, Q2, Q3, and Q4. However, the power supply 300 need not include all of the components Q1-Q4 and can implement the techniques of this disclosure with one of the components Q1-Q4 operating as a linear regulator, which are discussed in turn below.

The precise voltage position circuitry of FIG. 10 can include a reference voltage VREF, an error amplifier EA1, and a passive device configured to operate as a linear regulator, e.g., components Q1, Q2, Q3 or Q4. An output sourcing current (in configurations using components Q1 or Q3), or an opposite sinking current (in configurations using components Q2 or Q4), can be delivered via the passive device (e.g., components Q1, Q2, Q3 or Q4), which is controlled by the error amplifier EA1.

The error amplifier EA1 can receive the reference voltage VREF and the output voltage VOUT and then generate and output a signal VERROR representing the difference, e.g., an error, between the VREF and VOUT. This configuration can form a negative feedback loop that can drive the output voltage VOUT to equal the reference voltage VREF, thereby resulting in precise voltage positioning, as mentioned above with respect to FIGS. 8 and 9 and output voltages 192, 212, respectively. If the output voltage VOUT is lower than the reference voltage VREF, the negative feedback loop can drive more current, thereby increasing the output voltage VOUT. If the output voltage VOUT is higher than the reference voltage VREF, the negative feedback can drive less current, thereby decreasing the output voltage VOUT.

In some example output sourcing current configurations, the Q1 switch can be a component of the switching regulator, e.g., switching regulator 172 of FIG. 7, and can be “reused” (or “repurposed”) as a linear regulator, e.g., an LDO, and used in a linear regulation mode when the power supply 300 is not using the switched-mode power conversion. In other output sourcing current configurations, the Q1 switch can be an additional component in parallel with a component (not depicted) e.g., transistor, of the switching regulator, e.g., switching regulator 172 of FIG. 7, and used in a linear regulation mode.

In some example sinking current configurations, the Q2 switch can be a component of the switched-mode regulator, e.g., switching regulator 172 of FIG. 7, and can be “reused” (or “repurposed”) as an LDO and used in a linear regulation mode when the power supply 300 is not using the switched-mode power conversion. In other example sinking current configurations, the Q2 switch can be an additional component in parallel with a component (not depicted), e.g., transistor, of the switching regulator, e.g., switching regulator 172 of FIG. 7, and used in a linear regulation mode.

In some example configurations, a linear regulator can be added directly between an input voltage node VIN and an output voltage node VOUT. For example, as seen in FIG. 10, in an example output sourcing current configuration, the Q3 switch can be a component coupled between an input voltage node VIN and an output voltage node VOUT.

In some example configurations, a linear regulator can be added directly between a ground node and an output voltage node VOUT. For example, as seen in FIG. 10, in an example output sinking current configuration, the Q4 switch can be a component coupled between an output voltage node VOUT and a ground node.

In operation, the power supply 300 can generate an output voltage VOUT using a switched-mode power conversion using Q1 and Q2 of the power supply 300. In the switched-mode power conversion, components Q1 and Q2 can be switched alternatively (Q1 turns on first then off, Q2 turns on then off, etc.) to generate the output power. After the power supply 300 receives a first level of a first signal, e.g., the STOP signal 306, the controller 304 can stop the PWM switching of the switching regulator, e.g., the switching regulator 170 of FIG. 7. For example, in some examples in which the Q1 and Q2 switches are components of the switching regulator, the controller 304 can stop Q1 and Q2) PWM switching. After the power supply 300 has stopped generating an output voltage VOUT using the switched-mode power conversion, the power supply 300 can switch to linear mode and generate the output voltage VOUT using a linear regulation of the power supply 300.

As indicated above, the power supply 300 can include and operate one of Q1, Q2, Q3, or Q4 as linear regulators. If using Q1 (or Q2) as a linear regulator, Q1 (or Q2) can source (or sink) current to actively position the output voltage VOUT precisely in a short period. In particular, the PWM and linear controller 304 can adjust the linear regulation, e.g., by controlling Q1 (or Q2), based on a voltage feedback signal VERROR from the error amplifier EA1. After the power supply 300 regulates its output voltage VOUT to be at a particular level, then the power supply 300 can send a signal 308, e.g., CONV-OKAY signal, to a mixed-signal device, e.g., device 166 of FIG. 7, as an indication that the power supply 300 is ready for the precision operation of the mixed-signal device 166, e.g., data conversion. In some example implementations, the PWM and linear controller 304 can then stop Q1 (or Q2) and rely on the output capacitor COUT to supply the pulsed load current to load 302.

Optionally, in some example implementations, a switch Q5 can be included for fast damping of the inductor current in certain conditions. For example, Q1 (or Q2) can potentially introduce the charge (or sink) current IL1 through the inductor L1, which may continuously charge (or sink) the output even though Q1 (or Q2) is turned off. Turning on the Q5 switch can make the output voltage independent of the remaining inductor current IL1.

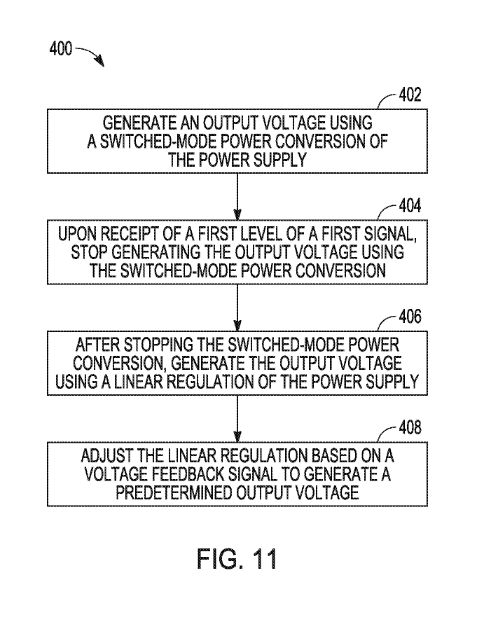

FIG. 11 is a flow diagram depicting an example method implementing various precise voltage positioning techniques of this disclosure. As seen in FIG. 11, the method 400 can include generating an output voltage using a switched-mode power conversion of the power supply (402). For example, the power supply 162 of FIG. 7 can generate an output voltage using the switching regulator 170. Upon receipt of a first level of a first signal, the method 400 can include stopping the generating using the switched-mode power conversion (block 404). For example, after the power supply 162 of FIG. 7 receives a logic high of a STOP signal 174, the power supply 162 can stop generating the switching regulator from generating the output voltage.

After stopping the generating using the switched-mode power conversion, the method 400 can include generating the output voltage using a linear regulation of the power supply (block 406). For example, after the power supply 162 of FIG. 7 stops generating the output voltage using the switching regulator 170, the power supply 162 can generate the output voltage using the linear regulator 172. The method 400 can include adjusting the linear regulation based on a voltage feedback signal to generate a predetermined output voltage (block 408). For example, the power supply 300 of FIG. 10, which is an example of the power supply 162 of FIG. 7, can adjust the linear regulation using a feedback voltage signal VERROR.

### Various Notes

Aspect 1 includes subject matter (such as a method) for controlling operation of a power supply that can include generating an output voltage using a switched-mode power conversion of the power supply; upon receipt of a first level of a first signal, stopping the generating using the switched-mode power conversion; after stopping the generating using the switched-mode power conversion, generating the output voltage using a linear regulation of the power supply; and adjusting the linear regulation based on a voltage feedback signal to generate a predetermined output voltage.

In Aspect 2, the subject matter of Aspect 1 can optionally include, upon generating the predetermined output voltage, generating a second signal having a first level.

In Aspect 3, the subject matter of Aspect 2 can optionally include, wherein the second signal having a first level indicates that the power supply is ready for a data conversion operation.

In Aspect 4, the subject matter of one or more of Aspects 1-3 can optionally include, after adjusting the linear regulation based on a voltage feedback signal, generating the output voltage using an output capacitor.

In Aspect 5, the subject matter of one or more of Aspects 1-4 can optionally include, upon receipt of a second level of the first signal, stopping the generating using the linear regulation of the power supply; and after stopping the generating using the linear regulation of the power supply, generating the output voltage using the switched-mode power conversion of the power supply.

In Aspect 6, the subject matter of one or more of Aspects 1-5 can optionally include, wherein generating an output voltage using a switched-mode power conversion of the power supply includes generating an output voltage using a switched-mode regulator of the power supply, and wherein after stopping the generating using the switched-mode power conversion, generating the output voltage using a linear regulation of the power supply includes generating the output voltage using a transistor of the switched-mode regulator.

In Aspect 7, the subject matter of one or more of Aspects 1-6 can optionally include, wherein generating an output voltage using a switched-mode power conversion of the power supply includes generating an output voltage using a switched-mode regulator of the power supply, and wherein after stopping the generating using the switched-mode power conversion, generating the output voltage using a linear regulation of the power supply includes generating the output voltage using a linear regulator in parallel with a transistor of the switched-mode regulator.

In Aspect 8, the subject matter of one or more of Aspects 1-7 can optionally include, wherein generating an output voltage using a switched-mode power conversion of the power supply includes generating an output voltage using a switched-mode regulator of the power supply, and wherein after stopping the generating using the switched-mode power conversion, generating the output voltage using a linear regulation of the power supply includes generating the output voltage using a linear regulator coupled between an input voltage node and an output voltage node.

In Aspect 9, the subject matter of one or more of Aspects 1-8 can optionally include, controlling damping circuitry to isolate the output voltage from an inductor current through an inductor of the switched-mode power conversion of the power supply.

In Aspect 10, the subject matter of one or more of Aspects 1-9 can optionally include, wherein generating an output voltage using a switched-mode power conversion of the power supply includes generating a sourcing current from an input voltage node.

In Aspect 11, the subject matter of one or more of Aspects 1-10 can optionally include, wherein generating an output voltage using a switched-mode power conversion of the power supply includes generating a sinking current from an output voltage node to a ground node.

Aspect 12 includes subject matter (such as an apparatus) that can include a switching regulator; a linear regulator; and a controller configured to: generate an output voltage using a switched-mode power conversion of the switching regulator; upon receipt of a first level of a first signal, stop generating the output voltage using the switched-mode power conversion; after stopping the generating using the switched-mode power conversion, generate the output voltage using a linear regulation of the linear regulator; and adjust the linear regulation based on a voltage feedback signal to generate a predetermined output voltage.

In Aspect 13, the subject matter of Aspect 12 can optionally include, wherein the controller is further configured to generate a second signal having a first level upon generating the predetermined output voltage.

In Aspect 14, the subject matter of Aspect 13 can optionally include, wherein the second signal having a first level indicates that the power supply is ready for a data conversion operation.

In Aspect 15, the subject matter of one or more of Aspects 12-14 can optionally include, wherein the controller is further configured to: after adjusting the linear regulation based on a voltage feedback signal, generate the output voltage using an output capacitor.

In Aspect 16, the subject matter of one or more of Aspects 12-15 can optionally include, wherein the controller is further configured to: upon receipt of a second level of the first signal, stop generating using the linear regulation of the power supply; and after stopping the generating using the linear regulation of the power supply, generate the output voltage using the switched-mode power conversion of the power supply.

In Aspect 17, the subject matter of one or more of Aspects 12-16 can optionally include, wherein the controller configured to generate an output voltage using a switched-mode power conversion of the power supply is configured to generate an output voltage using a switched-mode regulator of the power supply, and wherein the controller configured to generate the output voltage using a linear regulation of the power supply after stopping the generating using the switched-mode power conversion is further configured to generate the output voltage using a transistor of the switched-mode regulator.

In Aspect 18, the subject matter of one or more of Aspects 12-17 can optionally include, wherein the controller configured to generate an output voltage using a switched-mode power conversion of the power supply is configured to generate an output voltage using a switched-mode regulator of the power supply, and wherein the controller configured to generate the output voltage using a linear regulation of the power supply after stopping the generating using the switched-mode power conversion is further configured to generate the output voltage using a linear regulator in parallel with a transistor of the switched-mode regulator.

In Aspect 19, the subject matter of one or more of Aspects 12-18 can optionally include, wherein the controller configured to generate an output voltage using a switched-mode power conversion of the power supply is configured to generate an output voltage using a switched-mode regulator of the power supply, and wherein the controller configured to generate the output voltage using a linear regulation of the power supply after stopping the generating using the switched-mode power conversion is further configured to generate the output voltage using a linear regulator coupled between an input voltage node and an output voltage node.

In Aspect 20, the subject matter of one or more of Aspects 12-16 can optionally include, damping circuitry configured to isolate the output voltage from an inductor current through an inductor of the switched-mode power conversion of the power supply.

The above detailed description includes references to the accompanying drawings, which form a part of the detailed description. The drawings show, by way of illustration, specific embodiments in which the invention can be practiced. These embodiments are also referred to herein as “aspects.” Such aspects can include elements in addition to those shown or described. However, the present inventors also contemplate aspects in which only those elements shown or described are provided. Moreover, the present inventors also contemplate aspects using any combination or permutation of those elements shown or described (or one or more aspects thereof), either with respect to a particular aspect (or one or more aspects thereof), or with respect to other aspects (or one or more aspects thereof) shown or described herein.

In the event of inconsistent usages between this document and any documents so incorporated by reference, the usage in this document controls.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method of controlling operation of a power supply, the method comprising:
generating an output voltage using a switched-mode power conversion of the power supply;
upon receipt of a first level of a first signal, stopping the generating using the switched-mode power conversion;
after stopping the generating using the switched-mode power conversion, generating the output voltage using a linear regulation of the power supply; and
adjusting the linear regulation based on a second signal to generate a specified output voltage, wherein the second signal includes a voltage feedback signal.

2. The method of claim 1, further comprising:
upon generating the specified output voltage, generating a third signal having a first level.

3. The method of claim 2, wherein the third signal having a first level indicates that the power supply is ready for a data conversion operation.

4. The method of claim 1, further comprising:
after adjusting the linear regulation based on the second signal, generating the output voltage using an output capacitor.

5. The method of claim 1, further comprising:
upon receipt of a second level of the first signal, stopping the generating using the linear regulation of the power supply; and
after stopping the generating using the linear regulation of the power supply, generating the output voltage using the switched-mode power conversion of the power supply.

6. The method of claim 1,
wherein generating an output voltage using a switched-mode power conversion of the power supply includes generating an output voltage using a switched-mode regulator of the power supply, and
wherein after stopping the generating using the switched-mode power conversion, generating the output voltage using a linear regulation of the power supply includes generating the output voltage using a transistor of the switched-mode regulator.

7. The method of claim 1,
wherein generating an output voltage using a switched-mode power conversion of the power supply includes generating an output voltage using a switched-mode regulator of the power supply, and
wherein after stopping the generating using the switched-mode power conversion, generating the output voltage using a linear regulation of the power supply includes generating the output voltage using a linear regulator in parallel with a transistor of the switched-mode regulator.

8. The method of claim 1,
wherein generating an output voltage using a switched-mode power conversion of the power supply includes generating an output voltage using a switched-mode regulator of the power supply, and
wherein after stopping the generating using the switched-mode power conversion, generating the output voltage using a linear regulation of the power supply includes generating the output voltage using a linear regulator coupled between an input voltage node and an output voltage node.

9. The method of claim 1, further comprising:
controlling damping circuitry to isolate the output voltage from an inductor current through an inductor of the switched-mode power conversion of the power supply.

10. The method of claim 1, wherein generating an output voltage using a switched-mode power conversion of the power supply includes generating a sourcing current from an input voltage node.

11. The method of claim 1, wherein generating an output voltage using a switched-mode power conversion of the power supply includes generating a sinking current from an output voltage node to a ground node.

12. A power supply comprising:
a switching regulator;
a linear regulator; and
a controller configured to:
generate an output voltage using a switched-mode power conversion of the switching regulator;
upon receipt of a first level of a first signal, stop generating the output voltage using the switched-mode power conversion;
after stopping the generating using the switched-mode power conversion, generate the output voltage using a linear regulation of the linear regulator; and
adjust the linear regulation based on a second signal to generate a specified output voltage, wherein the second signal includes a voltage feedback signal.

13. The power supply of claim 12, wherein the controller is further configured to:
generate a third signal having a first level upon generating the specified output voltage.

14. The power supply of claim 13, wherein the third signal having a first level indicates that the power supply is ready for a data conversion operation.

15. The power supply of claim 12, wherein the controller is further configured to:
after adjusting the linear regulation based on the second signal, generate the output voltage using an output capacitor.

16. The power supply of claim 12, wherein the controller is further configured to:
upon receipt of a second level of the first signal, stop generating using the linear regulation of the power supply; and
after stopping the generating using the linear regulation of the power supply, generate the output voltage using the switched-mode power conversion of the power supply.

17. The power supply of claim 12,
wherein the controller configured to generate an output voltage using a switched-mode power conversion of the power supply is configured to generate an output voltage using a switched-mode regulator of the power supply, and
wherein the controller configured to generate the output voltage using a linear regulation of the power supply after stopping the generating using the switched-mode power conversion is further configured to generate the output voltage using a transistor of the switched-mode regulator.

18. The power supply of claim 12,
wherein the controller configured to generate an output voltage using a switched-mode power conversion of the power supply is configured to generate an output voltage using a switched-mode regulator of the power supply, and
wherein the controller configured to generate the output voltage using a linear regulation of the power supply after stopping the generating using the switched-mode power conversion is further configured to generate the output voltage using a linear regulator in parallel with a transistor of the switched-mode regulator.

19. The power supply of claim 12,
wherein the controller configured to generate an output voltage using a switched-mode power conversion of the power supply is configured to generate an output voltage using a switched-mode regulator of the power supply, and
wherein the controller configured to generate the output voltage using a linear regulation of the power supply after stopping the generating using the switched-mode power conversion is further configured to generate the output voltage using a linear regulator coupled between an input voltage node and an output voltage node.

20. The power supply of claim 12, further comprising:
damping circuitry configured to isolate the output voltage from an inductor current through an inductor of the switched-mode power conversion of the power supply.

21. A power supply circuit comprising:
means for generating an output voltage using a switched-mode power conversion of the power supply;
upon receipt of a first level of a first signal, means for stopping the generating using the switched-mode power conversion;
after stopping the generating using the switched-mode power conversion, means for generating the output voltage using a linear regulation of the power supply; and
means for adjusting the linear regulation based on a second signal to generate a specified output voltage, wherein the second signal includes a voltage feedback signal.
